(19) United States
(12) Patent Application Publication
(10) Pub. No.: US 2015/0192730 A1
(43) Pub. Date: Jul. 9, 2015

(54) DISPLAY APPARATUS AND METHOD OF MANUFACTURING THE SAME

(71) Applicant: Samsung Display Co., LTD., Yongin-City (KR)

(72) Inventor: Jung-Soo OK, Asan-si (KR)

(73) Assignee: Samsung Display Co., LTD., Yongin-City (KR)

(21) Appl. No.: 14/291,327

(22) Filed: May 30, 2014

(30) Foreign Application Priority Data
Jan. 3, 2014 (KR) 10-2014-0000674

(51) Int. Cl. F21V 8/00

(52) U.S. Cl. CPC G02B 6/0088; G02B 6/0075; G02B 6/005; G02B 6/0065; G02B 6/0091

(57) ABSTRACT

A display apparatus includes a display panel which displays an image, a light guiding plate disposed under the display panel, and a bottom chassis which receives the display panel and the light guiding plate and includes a bottom portion which is parallel to the display panel and extends in a first direction and a second direction substantially perpendicular to the first direction, and a first side portion including a first side wall portion which extends from a first side of the bottom portion along a third direction substantially perpendicular to the first and second directions, a first connecting portion which extends from the first side wall portion parallel to the bottom portion, and a first light guiding plate guiding portion which extends from the first connecting portion toward the bottom portion, where the first light guiding plate guiding portion contacts the light guiding plate.

This application claims priority to Korean Patent Application No. 10-2014-0000674, filed on Jan. 3, 2014, and all the benefits accruing therefrom under 35 U.S.C. §119, the invention of which is incorporated by reference herein in its entirety.

### BACKGROUND

1. Field

Exemplary embodiments of the invention relate to a display apparatus and a method of manufacturing the display apparatus.

More particularly, exemplary embodiments of the invention relate to a display apparatus for liquid crystal display apparatus and a method of manufacturing the display apparatus.

2. Description of the Related Art

Recently, a display apparatus having light weight and small size has been manufactured. A cathode ray tube (“CRT”) display apparatus has been used due to a performance and a competitive price. However, the CRT display apparatus has a weakness with a size or portability. Therefore, the liquid display apparatus has been highly regarded due to small size, light weight and low-power-consumption of the liquid display apparatus.

The liquid crystal display (“LCD”) apparatus applies a voltage to specific molecular arrangement configured to change the molecular arrangement. The LCD apparatus displays an image using changes of optical property (for example, birefringence, rotatory polarization, dichroism and light scattering) of a liquid crystal cell according to the changes of the molecular arrangement.

The LCD apparatus includes a display panel which displays an image, a backlight assembly supplying light to the display panel, and a receiving container receiving the display panel and backlight assembly.

### SUMMARY

A liquid crystal display (“LCD”) apparatus generally includes a receiving container and a mold frame which is disposed between a display panel and a backlight assembly, which causes a complex structure of the LCD apparatus.

One or more exemplary embodiment of the invention provides a display apparatus capable of simplifying a structure.

One or more exemplary embodiments of the invention also provide a method of manufacturing the display apparatus.

According to an exemplary embodiment of the invention, a display apparatus includes a display panel which displays an image, a light guiding plate disposed under the display panel, and a bottom chassis receiving the display panel and the light guiding plate. The bottom chassis includes a bottom portion, a first side portion, a second side portion, a third side portion and a fourth side portion. The first side portion includes a first side wall portion which extends from a first side of the bottom portion along a third direction substantially perpendicular to the first and second directions, a first connecting portion which extends from the first side wall portion in parallel with the bottom portion and a first light guiding plate guiding portion which extends from the first connecting portion toward the bottom portion. The second side portion includes a second side wall portion which extends along the third direction from a second side of the bottom portion opposite to the first side of the bottom portion along the second direction, a second connecting portion which extends from the second side wall portion in parallel with the bottom portion and a second light guiding plate guiding portion which extends from the second connecting portion toward the bottom portion. The third side portion includes a third side wall portion which extends along the third direction from a third side of the bottom portion adjacent to the first and second sides of the bottom portion, a third connecting portion which extends from the third side wall portion in parallel with the bottom portion and a third light guiding plate guiding portion which extends from the third connecting portion toward the bottom portion. The fourth side portion includes a fourth side wall portion which extends along the third direction from a fourth side of the bottom portion opposite to the third side of the bottom portion along the first direction, a fourth connecting portion which extends from the fourth side wall portion in parallel with the bottom portion and a fourth light guiding plate guiding portion which extends from the fourth connecting portion toward the bottom portion.

In an exemplary embodiment, the first light guiding plate guiding portion may contact a portion of a side surface of the light guiding plate.

In an exemplary embodiment, the first connecting portion may contact a portion of a bottom surface of the display panel.

In an exemplary embodiment, the light guiding plate may include a first protrusion provided on a first side surface of the light guiding plate. A first protrusion receiving space which receives the first protrusion of the light guide plate may be defined in the first side portion of the bottom chassis.

In an exemplary embodiment, the first protrusion receiving space of the first side portion may be defined by a portion of the first connecting portion and the first light guiding plate guiding portion of the first side portion.

In an exemplary embodiment, the first side portion may further comprise a protrusion fixing portion provided at the first protrusion receiving space. The protrusion fixing portion may extend from the first side portion toward the first protrusion of the light guiding plate.

In an exemplary embodiment, the protrusion fixing portion may be protruded from the first connecting portion of the first side portion. The protrusion fixing portion may be inclined with respect to the third direction.

In an exemplary embodiment, the display apparatus may further include a first elastic element disposed between the first protrusion and the display panel. The first elastic element may include an elastic material. The first elastic element may contact with the display panel.

In an exemplary embodiment, the first side portion may further include a first display panel guiding portion disposed on the first connecting portion and contacting with a side surface of the display panel.

In an exemplary embodiment, the first display panel guiding portion may be adjacent to the first protrusion receiving space.

In an exemplary embodiment, the display apparatus may further include an optical element disposed between the display panel and the light guiding plate. The optical element may include a first protrusion protruded from a first side of the optical element. The first protrusion of the optical element may contact with the first protrusion of the light guiding plate.

In an exemplary embodiment, the display apparatus may further include a top chassis combined with the bottom chassis. The top chassis may include a bezel portion covering a portion of a boundary of a top surface of the display panel, and side surfaces extending from the bezel portion.

In an exemplary embodiment, the first side portion may further include a light guiding plate fixing portion protruded from the first light guiding plate guiding portion. The light guiding plate fixing portion may contact with the light guiding plate.

In an exemplary embodiment, the first side portion may further include a first display panel guiding portion disposed on the first connecting portion and contacting with a side surface of the display panel.

In an exemplary embodiment, the display apparatus may further include a light source which generates light and is disposed in the first side portion. The light source may extend along the first side wall portion in the first direction, and be disposed between the bottom portion and the first connecting portion.

According to an exemplary embodiment of the invention, a display apparatus includes a display panel which displays an image, a light guiding plate disposed under the display panel, and a bottom chassis which receives the display panel and the light guiding plate. The bottom chassis includes a bottom portion and a first side portion. The bottom portion is disposed in parallel with the display panel, and extends in a first direction and a second direction substantially perpendicular to the first direction. The first side portion includes a first side wall portion which extends from a first side of the bottom portion along a third direction substantially perpendicular to the first and second directions, a first connecting portion which extends from the first side wall portion in parallel with the bottom portion and a first light guiding plate guiding portion which extends from the first connecting portion toward the bottom portion. The first light guiding plate guiding portion may contact with a portion of a side surface of the light guiding plate.

According to an exemplary embodiment of the invention, a method of manufacturing a display apparatus providing a bottom chassis comprising a bottom portion and first to forth side portions extending from the bottom portion, receiving a light guiding plate into the bottom chassis by locating a first protrusion of the light guiding plate into a first protrusion receiving space of a first side portion of the bottom chassis, and locating a display panel on first to fourth connecting portions of the bottom chassis. The bottom portion of the bottom chassis is disposed in parallel with the display panel, and extends in a first direction and a second direction substantially perpendicular to the first direction. The first side portion includes a first side wall portion which extends from a first side of the bottom portion along a third direction substantially perpendicular to the first and second directions, the first connecting portion which extends from the first side wall portion in parallel with the bottom portion and a first light guiding plate guiding portion which extends from the first connecting portion toward the bottom portion. The first protrusion of the light guiding plate is protruded from a first side surface of the light guiding plate. The first protrusion receiving space to receive the first protrusion may be defined in the first side portion.

In an exemplary embodiment, providing the bottom chassis may further include bending the first side wall portion in a direction substantially perpendicular to the bottom portion, bending the first connecting portion in a direction substantially perpendicular to the first side wall portion and in parallel with the bottom portion, and bending the first light guiding plate guiding portion in a direction substantially perpendicular to the first connecting portion and toward the bottom portion.

In an exemplary embodiment, the first side portion may further include a first display panel guiding portion extending from the first connecting portion and a protrusion fixing portion. Providing the bottom chassis may further include bending the first display panel guiding portion in a direction which is substantially perpendicular to the first connecting portion, and bending the protrusion fixing portion from the first connecting portion toward the bottom portion.

In an exemplary embodiment, providing the bottom chassis may further include providing a convex portion on the bottom portion by a press process.

According to the invention, a display apparatus includes a bottom chassis receiving a display panel, an optical element and a light guiding plate and including first to fourth side portions, so that elements in the display apparatus may be firmly fixed in the display apparatus without a mold frame. Thus, a structure of the display apparatus may be simplified.

In addition, an exemplary embodiment of a method of manufacturing the display apparatus includes forming the bottom chassis by a press process, a cutting process and a bending process, for example. Thus, the method of manufacturing the display apparatus may be simplified.

### BRIEF DESCRIPTION OF THE DRAWINGS

The above and other features of the invention will become more apparent by describing in detail exemplary embodiments thereof with reference to the accompanying drawings, in which:

FIG. 1 is an exploded perspective view illustrating an exemplary embodiment of a display apparatus according the invention;

FIG. 2 is a cross-sectional view taken along line I-I′ of FIG. 1;

FIG. 3 is a cross-sectional view taken along line II-II′ of FIG. 1;

FIG. 4 is a partially enlarged view illustrating a combination of a protrusion of a display panel of FIG. 1 and a protrusion receiving space of a bottom chassis;

FIG. 5 is a cross-sectional view taken along line III-III′ of FIG. 4;

FIG. 6 is a partially enlarged view illustrating an exemplary embodiment of a combination of a protrusion of a display panel of FIG. 1 and a protrusion receiving space of a bottom chassis according to the invention;

FIG. 7 is a cross-sectional view taken along line III-III′ of FIG. 6;

FIG. 8 is an exploded perspective view illustrating an exemplary embodiment of a display apparatus according the invention;

FIG. 9 is a cross-sectional view taken along line I-I′ of FIG. 8;

FIG. 10 is a cross-sectional view taken along line II-II′ of FIG. 8;

FIG. 11 is an exploded perspective view illustrating an exemplary embodiment of a display apparatus according the invention;

FIG. 12 is a cross-sectional view taken along line I-I′ of FIG. 11;

FIG. 13 is a cross-sectional view taken along line II-II′ of FIG. 11; and

FIGS. 14 to 16 are perspective views illustrating a method of manufacturing a bottom chassis of a display apparatus of FIG. 1.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, the invention will be explained in detail with reference to the accompanying drawings.

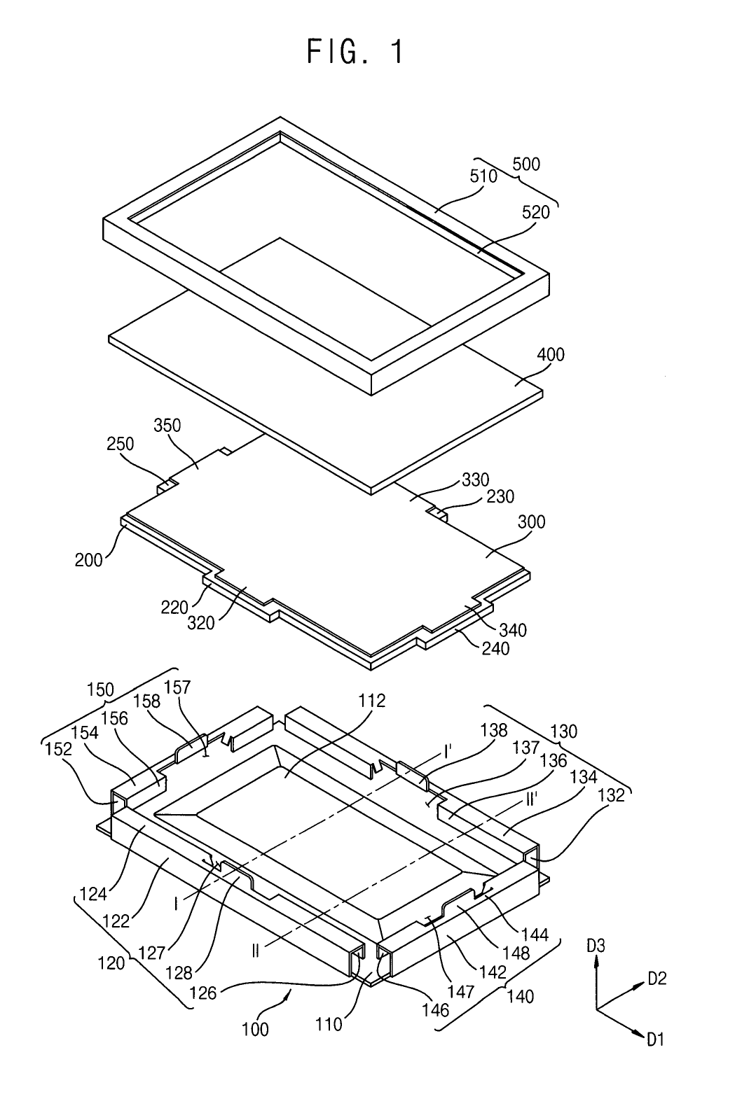

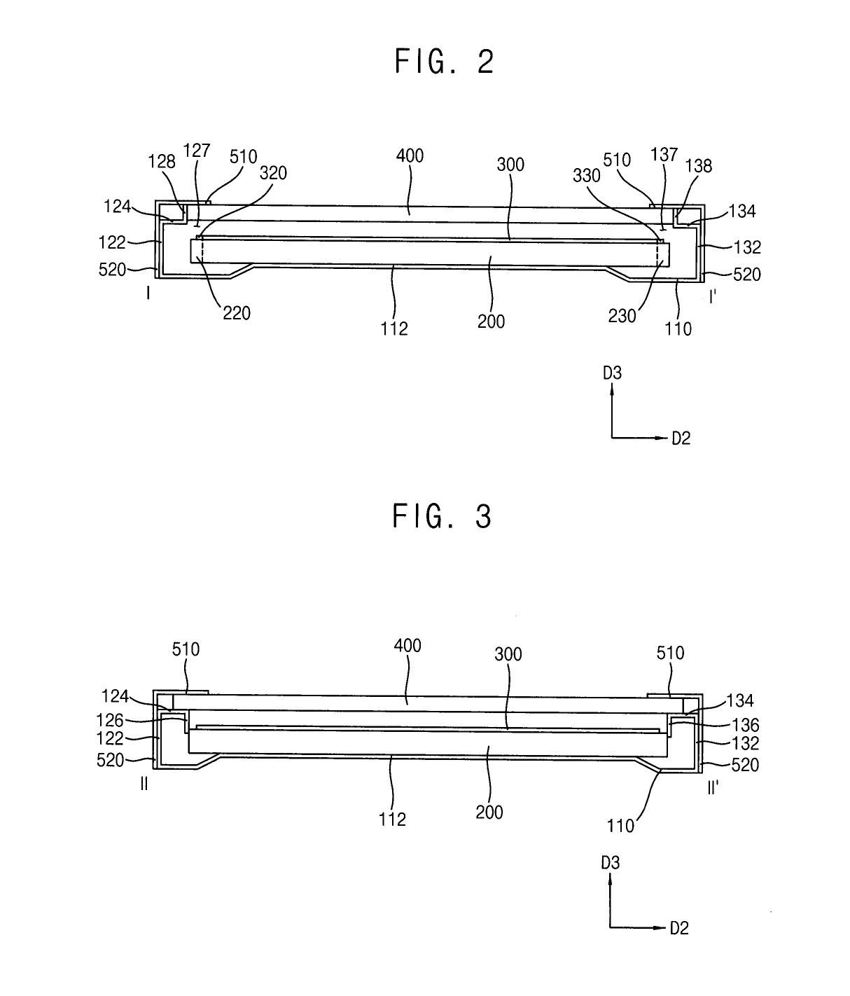

FIG. 1 is an exploded perspective view illustrating a display apparatus according an exemplary embodiment of the invention. FIG. 2 is a cross-sectional view taken along line I-I′ of FIG. 1. FIG. 3 is a cross-sectional view taken along line II-II′ of FIG. 1.

Referring to FIGS. 1 to 3, a display apparatus includes a backlight assembly including a light guiding plate 200, an optical element 300, a display panel 400 and a receiving container. The receiving container receives a backlight assembly, an optical element 300 and the display panel 400. The receiving container includes a bottom chassis 100 and a top chassis 500.

The backlight assembly supplies light to the display panel 400, and includes a light guiding plate 200 and a light source part (not shown) which generates the light. The light guiding plate 200 guides the light from the light source to the display panel 400. The light guiding plate 200 converts an incident light having a light distribution of a spot light source or a line light source to an exiting light having a light distribution of a surface light source. Thus, the light guiding plate 200 guides the light from the light source toward the display panel 400. Although the light guiding plate 200 is described having uniform thickness in the illustrated exemplary embodiment, the invention is not limited thereto, and the light guiding plate 200 may have various other shapes. In an exemplary embodiment, the light guiding plate 200 may have a wedge shaped cross section, for example. In the exemplary embodiment, thickness of the light guiding plate 200 may decrease as a distance from the light source decreases, to provide the wedge shaped cross section.

The bottom chassis 100 receives the light guiding plate 200, the optical element 300 and the display panel 400. In an exemplary embodiment, the bottom chassis 100 may include metal, for example. In the exemplary embodiment, the bottom chassis 100 may include aluminum or alloy including aluminum, for example. The bottom chassis 100 includes a bottom portion 110, a first side portion 120, a second side portion 130, a third side portion 140 and a fourth side portion 150.

The bottom portion 110 extends in a first direction D1 and a second direction D2 which is substantially perpendicular to the first direction D1. The bottom portion 110 may include a convex portion 112. The convex portion 112 is disposed at a center of the bottom portion 110, and protrudes toward the light guiding plate 200. The convex portion 112 makes contact with the light guiding plate 200.

The first side portion 120 extends from a first side of the bottom portion 110. The first side portion 120 includes a first side wall portion 122, a first connecting portion 124 and a first light guiding plate guiding portion 126. The first side wall portion 122 extends from the first side of the bottom portion 110 in a third direction D3 perpendicular to the first and second directions D1 and D2. The first connecting portion 124 extends from the first side wall portion 122 in parallel with the bottom portion 110. Accordingly, the bottom portion 110, the first side wall portion 122 and the first connecting portion 124 may provide a C-shape in a cross-sectional view. The first light guiding plate guiding portion 126 extends from the first connecting portion 124 toward the bottom portion 110. The first light guiding plate guiding portion 126 may contact a portion of the light guiding plate 200, so that the light guiding plate 200 may be fixed in the receiving container.

A portion of the first connecting portion 124 and a portion of first light guiding plate guiding portion 126 are removed, so that a first protrusion receiving space 127 is defined. A first protrusion 220 of the light guiding plate 200 may be received in the first protrusion receiving space 127.

A first display panel guiding portion 128 may be provided adjacent to the first protrusion receiving space 127. A portion of a bottom surface of the display panel 400 makes contact with the first connecting portion 124, and the first display panel guiding portion 128 makes contact with a portion of a side surface of the display panel 400, so that the display panel 400 may be fixed in the receiving container.

The second side portion 130 extends from a second side of the bottom portion 110. The second side of the bottom portion 110 is opposite to the first side of the bottom portion 110 in the second direction D2. The second side portion 130 includes a second side wall portion 132, a second connecting portion 134 and a second light guiding plate guiding portion 136. The second side wall portion 132 extends from the second side of the bottom portion 110 in the third direction D3. The second connecting portion 134 extends from the second side wall portion 132 in parallel with the bottom portion 110. Accordingly, the bottom portion 110, the second side wall portion 132 and the second connecting portion 134 may provide a C-shape in a cross-sectional view. The second light guiding plate guiding portion 136 extends from the second connecting portion 134 toward the bottom portion 110. The second light guiding plate guiding portion 136 may contact a portion of the light guiding plate 200, so that the light guiding plate 200 may be fixed in the receiving container.

A portion of the second connecting portion 134 and a portion of the second light guiding plate guiding portion 136 are removed, so that a second protrusion receiving space 137 is defined. A second protrusion 230 of the light guiding plate 200 may be received in the second protrusion receiving space 137.

A second display panel guiding portion 138 may be provided adjacent to the second protrusion receiving space 137. A portion of a bottom surface of the display panel 400 makes contact with the second connecting portion 134, and the second display panel guiding portion 138 makes contact with a portion of a side surface of the display panel 400, so that the display panel 400 may be fixed in the receiving container.

The third side portion 140 extends from a third side of the bottom portion 110. The third side of the bottom portion 110 is adjacent to the first and second sides of the bottom portion 110. The third side portion 140 includes a third side wall portion 142, a third connecting portion 144 and a third light guiding plate guiding portion 146. The third side wall portion 142 extends from the third side of the bottom portion 110 in the third direction D3. The third connecting portion 144 extends from the third side wall portion 142 in parallel with the bottom portion 110. Accordingly, the bottom portion 110, the third side wall portion 142 and the third connecting portion 144 may provide a C-shape in a cross-sectional view. The third light guiding plate guiding portion 146 extends from the third connecting portion 144 toward the bottom portion 110. The third light guiding plate guiding portion 146 may contact a portion of the light guiding plate 200, so that the light guiding plate 200 may be fixed in the receiving container.

A portion of the third connecting portion 144 and a portion of the third light guiding plate guiding portion 146 are removed, so that a third protrusion receiving space 147 is defined. A third protrusion 240 of the light guiding plate 200 may be received in the third protrusion receiving space 147.

A third display panel guiding portion 148 may be provided adjacent to the third protrusion receiving space 147. A portion a bottom surface of the display panel 400 makes contact with the third connecting portion 144, and the third display panel guiding portion 148 makes contact with a portion of a side surface of the display panel 400, so that the display panel 400 may be fixed in the receiving container.

The fourth side portion 150 extends from a fourth side of the bottom portion 110. The fourth side of the bottom portion 110 is opposite to the third side of the bottom portion 110 in the first direction D1. The fourth side portion 150 includes a fourth side wall portion 152, a fourth connecting portion 154 and a fourth light guiding plate guiding portion 156. The fourth side wall portion 152 extends from the fourth side of the bottom portion 110 in the third direction D3. The fourth connecting portion 154 extends from the fourth side wall portion 152 in parallel with the bottom portion 110. Accordingly, the bottom portion 110, the fourth side wall portion 152 and the fourth connecting portion 154 may provide a C-shape in a cross-sectional view. The fourth light guiding plate guiding portion 156 extends from the fourth connecting portion 154 toward the bottom portion 110. The fourth light guiding plate guiding portion 156 may contact a portion of the light guiding plate 200, so that the light guiding plate 200 may be fixed in the receiving container.

A portion of the fourth connecting portion 154 and a portion of the fourth light guiding plate guiding portion 156 are removed, so that a fourth protrusion receiving space 157 is defined. A fourth protrusion 250 of the light guiding plate 200 may be received in the fourth protrusion receiving space 157.

A fourth display panel guiding portion 158 may be provided adjacent to the fourth protrusion receiving space 157. A portion a bottom surface of the display panel 400 makes contact with the fourth connecting portion 154, and the fourth display panel guiding portion 158 makes contact with a portion of a side surface of the display panel 400, so that the display panel 400 may be fixed in the receiving container.

The first to fourth side portions 120 to 150 and the bottom portion 110 define a space for receiving the light guiding plate 200, the optical element 300 and the display panel 400.

The light guiding plate 200 is received in the bottom chassis 100, and disposed on the bottom portion 110 of the bottom chassis 100. The light guiding plate 200 may make contact with the convex portion 112 of the bottom portion 110. The light guiding plate 200 includes the first to fourth protrusions 220 to 250 respectively protrudes from the first to fourth sides of the light guiding plate 200.

The first protrusion 220 is provided by protruding from a first side surface of the light guiding plate 200. The first protrusion 220 is received in the first protrusion receiving space 127 of the bottom chassis 100.

The second protrusion 230 is provided by protruding from a second side surface of the light guiding plate 200. The second side surface is opposite to the first side surface in the second direction D2. The second protrusion 230 is received in the second protrusion receiving space 137 of the bottom chassis 100.

The third protrusion 240 is provided by protruding from a third side surface of the light guiding plate 200. The third side surface is adjacent to the first and second side surfaces. The third protrusion 240 is received in the third protrusion receiving space 147 of the bottom chassis 100.

The fourth protrusion 250 is provided by protruding from a fourth side surface of the light guiding plate 200. The fourth side surface is opposite to the third side surface in the first direction D1. The fourth protrusion 250 is received in the fourth protrusion receiving space 157 of the bottom chassis 100.

The first to fourth protrusions 220, 230, 240 and 250 are received in the first to fourth protrusion receiving spaces 127, 137, 147 and 157, respectively, so that the light guiding plate 200 may be firmly fixed in the bottom chassis 100 without a movement in the first and second direction D1 and D2.

The optical element 300 is disposed on the light guiding plate 200. The optical element 300 may have first to fourth protrusions 320, 330, 340 and 350 corresponding to the first to fourth protrusions 220, 230, 240 and 250 of the light guiding plate 200, respectively. The first protrusion 320 is provided at a side of the optical element 300, and the first protrusion 320 is attached on the first protrusion 220 of the light guiding plate 200, so that the optical element 300 may be disposed on the light guiding plate 200. Similarly, the second, third and fourth protrusions 330, 340 and 350 may be attached on the second to fourth protrusions 230, 240 and 250 of the light guiding plate 200.

The optical element 300 may improve optical property of the light from the light guiding plate 200. Thus, the optical element 300 may make brightness of the light from the light guiding plate 200 be uniform. In an exemplary embodiment, the optical element 300 may include plurality of optical sheets. In the exemplary embodiment, optical element 300 may include a protecting sheet, a prism sheet and a diffusion sheet, for example. In the exemplary embodiment, the prism sheet may include an upper prism sheet and a lower prism sheet, for example. In the exemplary embodiment, an axis of the upper prism sheet may be substantially perpendicular to an axis of the lower prism sheet. Although the optical element 300 is described to include the protecting sheet, the prism sheet and the diffusion sheet in the exemplary embodiment, the invention is not limited thereto, and various modifications of the optical sheet may be possible.

The display panel 400 displays an image using light from the backlight assembly according to driving signal and data signal applied from outside. The display panel 400 includes an array substrate, an opposite substrate facing the array substrate, and a liquid crystal layer disposed between the array substrate and the opposite substrate.

In an exemplary embodiment, the array substrate may include a plurality of gate lines, a plurality of data lines crossing the gate lines, and a plurality of switching element connected to the gate and data lines, for example. In an exemplary embodiment, the opposite substrate may include a black matrix blocking light and a color filter having a color, for example. In an exemplary embodiment, the color filter may be disposed in the array substrate. The liquid crystal layer is disposed between the array substrate and the opposite substrate. The liquid crystal layer includes liquid crystal molecules having optically anisotropic. The liquid crystal molecules are driven by electric field, so that light may pass through or be blocked by the liquid crystal layer to display an image.

The top chassis 500 includes a bezel portion 510 covering a boundary of the top surface of the display panel 400, and side surfaces 520 extending from the bezel portion 510. The top chassis 500 may be combined with the bottom chassis 100 to receive the display panel 400, the optical element 300 and the light guiding plate 200.

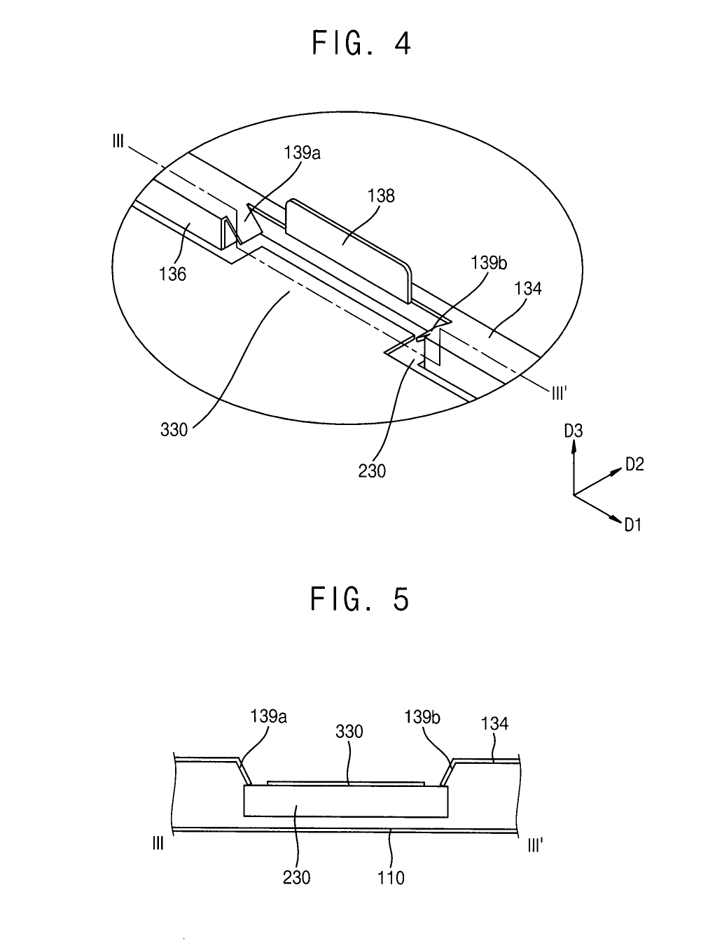

FIG. 4 is a partially enlarged view illustrating a combination of a protrusion of a display panel of FIG. 1 and a protrusion receiving space of a bottom chassis. FIG. 5 is a cross-sectional view taken along line III-III′ of FIG. 4.

Referring to FIGS. 1 to 6, a portion of a second connecting portion 134 of a second side portion 130 of a bottom chassis 100 and a portion of a second light guiding plate guiding portion 136 are removed to define a second protrusion receiving space 137. A second protrusion 230 of a light guiding plate 200 is received in the second protrusion receiving space 137.

Referring to FIG. 4, protrusion fixing portions 139a and 139b are protruded from the second connecting portion 134 toward the second protrusion 230. In an exemplary embodiment, the protrusion fixing portions 139a and 139b are provided by bending a portion of the second connecting portion 134 adjacent to the second protrusion receiving space 137. Two protrusion fixing portions 139a and 139b may be provided corresponding to both ends of the second protrusion 230 of the light guiding plate 200. Thus, when the second protrusion 230 of the light guiding plate 200 is received in the second protrusion receiving space 137 of the second side portion 130, the light guiding plate 200 may be fixed in the bottom chassis 100 by the protrusion fixing portions 139a and 139b.

Similarly, a protrusion fixing portion may be provided at a first protrusion receiving space 127 of a first side portion 120, a third protrusion receiving space 147 of a third side portion 140 and a fourth protrusion receiving space 157 of a fourth side portion 150 of the bottom chassis 100, respectively.

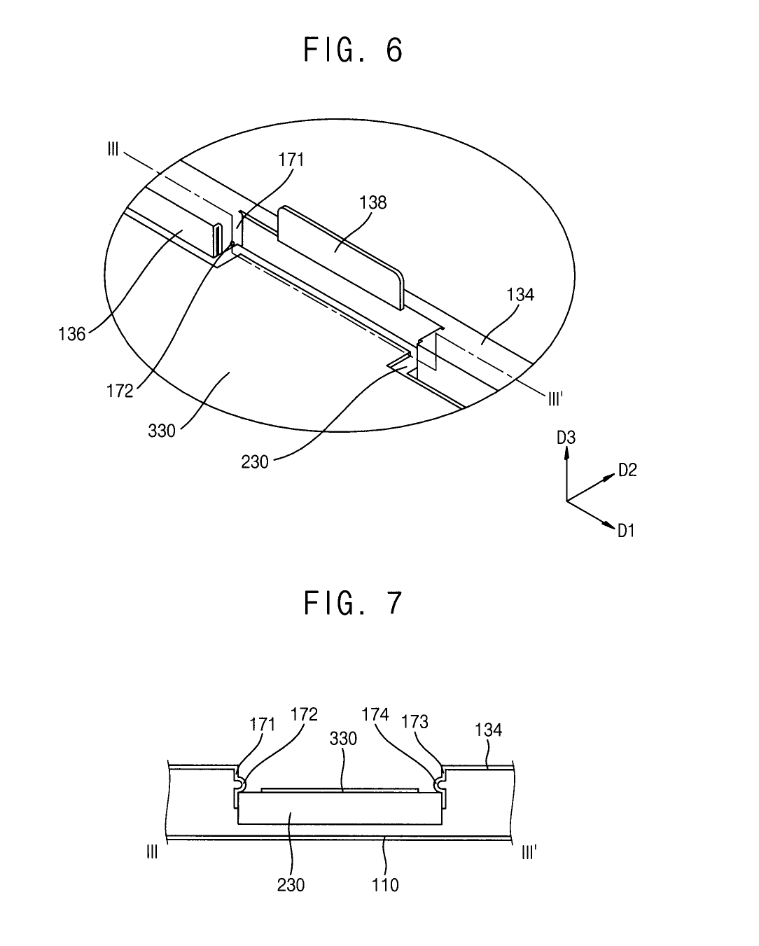

FIG. 6 is a partially enlarged view illustrating a combination of a protrusion of a display panel of FIG. 1 and a protrusion receiving space of a bottom chassis according to an exemplary embodiment of the invention. FIG. 7 is a cross-sectional view taken along line III-III′ of FIG. 6.

Referring to FIGS. 6 and 7, a display apparatus is substantially same as a display apparatus of FIGS. 1 to 5, except for extending portions 171 and 173 and bumps 172 and 174. Thus, any further detailed descriptions concerning the same elements will be briefly described or be omitted.

The extending portions 171 and 173 extend from the second connecting portion 134 toward the bottom portion 110 (refers to of FIG. 1). In an exemplary embodiment, the extending portions 171 and 173 may be provided by bending a portion of the second connecting portion 134 adjacent to the second protrusion receiving space 137. The bumps 172 and 174 are disposed on the extending portions 171 and 173. The extending portions 171 and 173 and the bumps 172 and 174 are provided in pair to correspond to both ends of the second protrusion 230 of the light guiding plate 200. Thus, when the second protrusion 230 of the light guiding plate 200 is received in the second protrusion receiving space 137 of the second side portion 130, the light guiding plate 200 may be fixed in the bottom chassis 100 by the bumps 172 and 174.

Similarly, an extending portion and a bump may be provided at the first protrusion receiving space 127 of the first side portion 120, the third protrusion receiving space 147 of the third side portion 140 and the fourth protrusion receiving space 157 of the fourth side portion 150 of the bottom chassis 100, respectively.

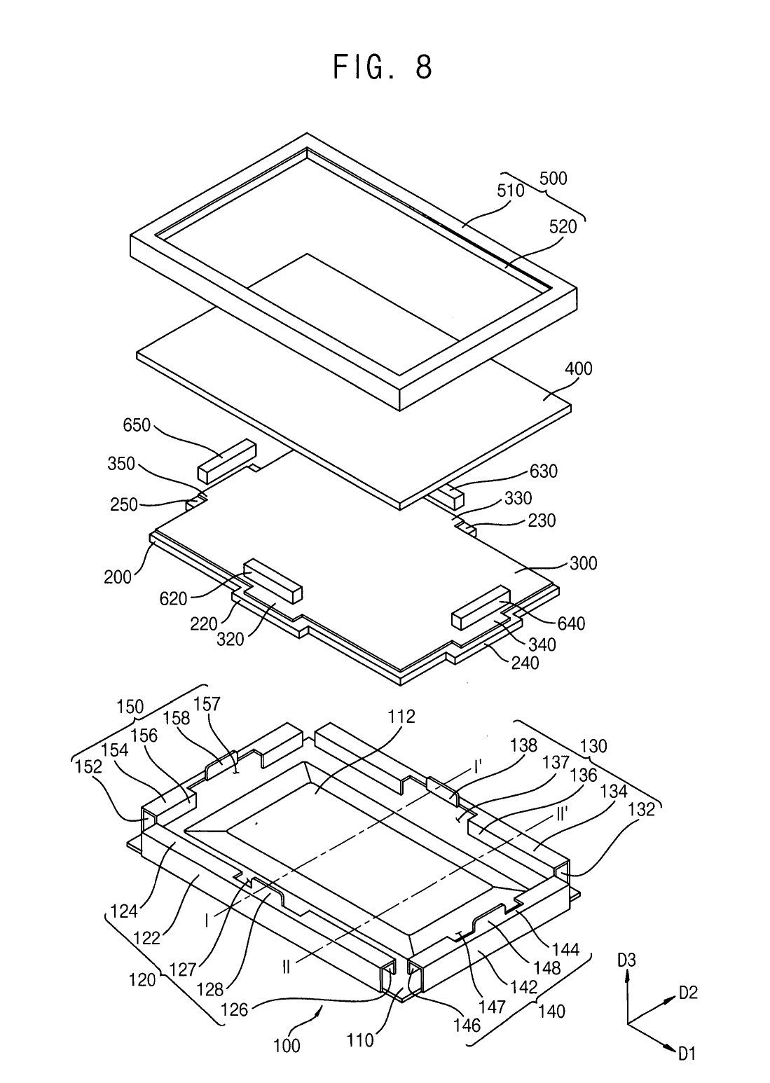

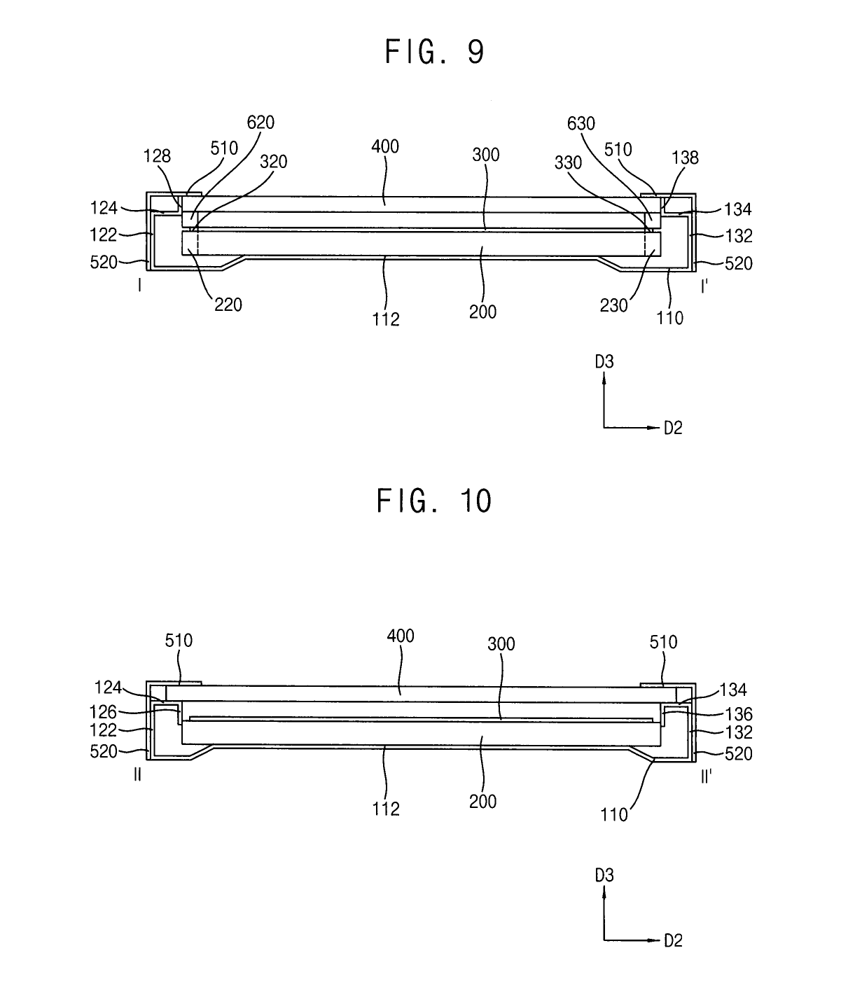

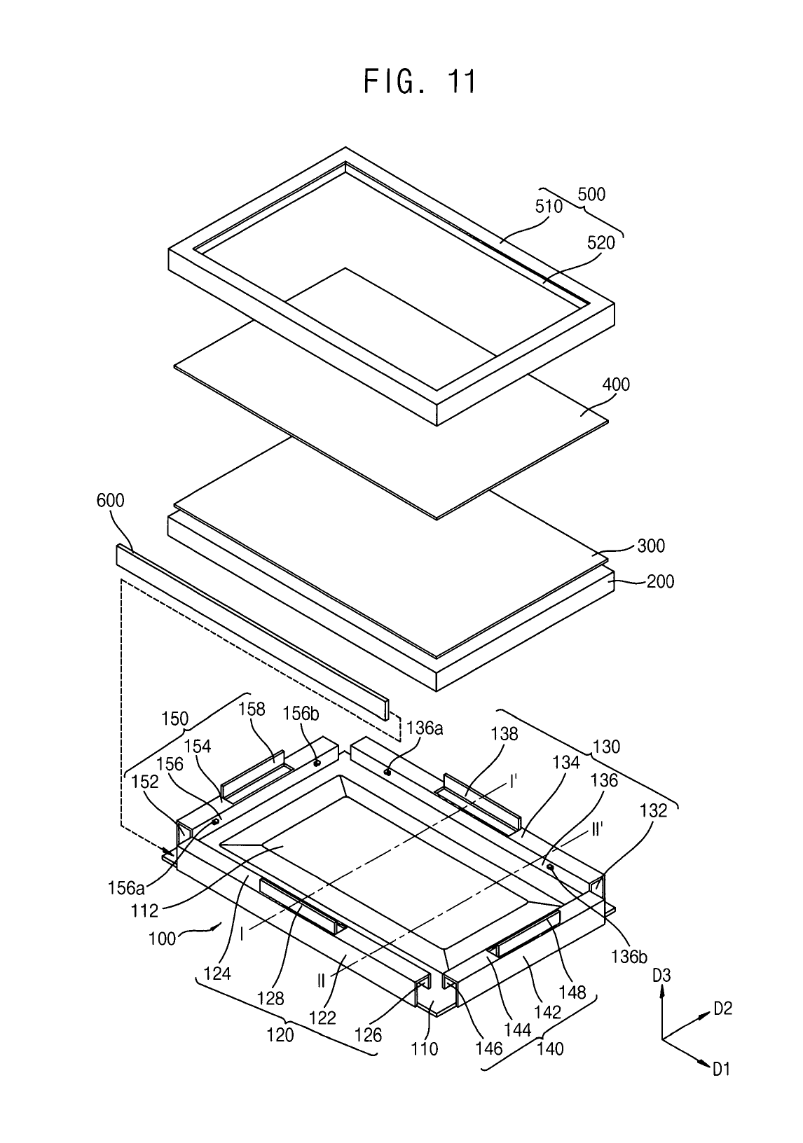

FIG. 8 is an exploded perspective view illustrating a display apparatus according an exemplary embodiment of the invention. FIG. 9 is a cross-sectional view taken along line I-I′ of FIG. 8. FIG. 10 is a cross-sectional view taken along line II-II′ of FIG. 8.

Referring to FIGS. 8 and 10, a display apparatus is substantially same as a display apparatus of FIG. 1, except that first to fourth elastic elements 620, 630, 640 and 650 fix a light guiding plate instead of a protrusion fixing portion. Thus, any further detailed descriptions concerning the same elements will be briefly described or be omitted.

The display apparatus includes a backlight assembly including a light guiding plate 200, an optical element 300, a display panel 400 and a receiving container. The receiving container receives a backlight assembly, an optical element 300 and the display panel 400. The receiving container includes a bottom chassis 100 and a top chassis 500.

The backlight assembly supplies light to the display panel 400, and includes a light guiding plate 200 and a light source part (not shown) which generates the light. The light guiding plate 200 guides the light from the light source to the display panel 400.

The bottom chassis 100 receives the light guiding plate 200, the optical element 300 and the display panel 400. The bottom chassis 100 includes a bottom portion 110, a first side portion 120, a second side portion 130, a third side portion 140 and a fourth side portion 150.

The bottom portion 110 extends in a first direction D1 and a second direction D2 which is substantially perpendicular to the first direction D1. The bottom portion 110 may include a convex portion 112.

The first side portion 120 extends from a first side of the bottom portion 110. The first side portion 120 includes a first side wall portion 122, a first connecting portion 124 and a first light guiding plate guiding portion 126. A portion of the first connecting portion 124 and a portion of first light guiding plate guiding portion 126 are removed, so that a first protrusion receiving space 127 is defined. A first display panel guiding portion 128 may be provided adjacent to the first protrusion receiving space 127.

The second side portion 130 extends from a second side of the bottom portion 110. The second side of the bottom portion 110 is opposite to the first side of the bottom portion 110 in the second direction D2. The second side portion 130 includes a second side wall portion 132, a second connecting portion 134 and a second light guiding plate guiding portion 136. A portion of the second connecting portion 134 and a portion of the second light guiding plate guiding portion 136 are removed, so that a second protrusion receiving space 137 is defined. A second display panel guiding portion 138 may be provided adjacent to the second protrusion receiving space 137.

The third side portion 140 extends from a third side of the bottom portion 110. The third side of the bottom portion 110 is adjacent to the first and second sides of the bottom portion 110. The third side portion 140 includes a third side wall portion 142, a third connecting portion 144 and a third light guiding plate guiding portion 146. A portion of the third connecting portion 144 and a portion of the third light guiding plate guiding portion 146 are removed, so that a third protrusion receiving space 147 is defined. A third display panel guiding portion 148 may be provided adjacent to the third protrusion receiving space 147.

The fourth side portion 150 extends from a fourth side of the bottom portion 110. The fourth side of the bottom portion 110 is opposite to the third side of the bottom portion 110 in the first direction D1. The fourth side portion 150 includes a fourth side wall portion 152, a fourth connecting portion 154 and a fourth light guiding plate guiding portion 156. A portion of the fourth connecting portion 154 and a portion of the fourth light guiding plate guiding portion 156 are removed, so that a fourth protrusion receiving space 157 is defined. A fourth display panel guiding portion 158 may be provided adjacent to the fourth protrusion receiving space 157.

The light guiding plate 200 is received in the bottom chassis 100, and disposed on the bottom portion 110 of the bottom chassis 100. The light guiding plate 200 includes the first to fourth protrusions 220, 230, 240 and 250 each of which protrudes from each side of the light guiding plate 200.

The first protrusion 220 is provided by protruding from a first side surface of the light guiding plate 200. The first protrusion 220 is received in the first protrusion receiving space 127 of the bottom chassis 100.

The second protrusion 230 is provided by protruding from a second side surface of the light guiding plate 200. The second side surface is opposite to the first side surface in the second direction D2. The second protrusion 230 is received in the second protrusion receiving space 137 of the bottom chassis 100.

The third protrusion 240 is provided by protruding from a third side surface of the light guiding plate 200. The third side surface is adjacent to the first and second side surfaces. The third protrusion 240 is received in the third protrusion receiving space 147 of the bottom chassis 100.

The fourth protrusion 250 is provided by protruding from a fourth side surface of the light guiding plate 200. The fourth side surface is opposite to the third side surface in the first direction D1. The fourth protrusion 250 is received in the fourth protrusion receiving space 157 of the bottom chassis 100.

The optical element 300 is disposed on the light guiding plate 200. The optical element 300 may have first to fourth protrusions 320, 330, 340 and 350 corresponding to the first to fourth protrusions 220, 230, 240 and 250 of the light guiding plate 200, respectively.

The display panel 400 displays an image using light from the backlight assembly according to driving signal and data signal applied from outside. The display panel 400 includes an array substrate, an opposite substrate facing the array substrate, and a liquid crystal layer disposed between the array substrate and the opposite substrate.

The first to fourth elastic elements 620, 630, 640 and 650 are disposed between the optical element 300, which is disposed on the light guiding plate 200, and the display panel 400 to fix the light guiding plate 200 and the display panel 400 in the receiving container. The first to fourth elastic elements 620, 630, 640 and 650 include an elastic material. In an exemplary embodiment, the first to fourth elastic elements 620, 630, 640 and 650 may include silicon, rubber and the like.

The first elastic element 620 is disposed between the first protrusion 320 of the optical element 300 and the display panel 400. The first elastic element 620 makes contact with the first protrusion 320 of the optical element 300 and the display panel 400.

The second elastic element 630 is disposed between the second protrusion 330 of the optical element 300 and the display panel 400. The second elastic element 630 makes contact with the second protrusion 330 of the optical element 300 and the display panel 400.

The third elastic element 640 is disposed between the third protrusion 340 of the optical element 300 and the display panel 400. The third elastic element 640 makes contact with the third protrusion 340 of the optical element 300 and the display panel 400.

The fourth elastic element 650 is disposed between the fourth protrusion 350 of the optical element 300 and the display panel 400. The fourth elastic element 650 makes contact with the fourth protrusion 350 of the optical element 300 and the display panel 400.

The first to fourth elastic elements 620, 630, 640 and 650 includes an elastic material, and make contact with the first to fourth protrusions 320, 330, 340 and 350 of the optical element 300, respectively, and the display panel 400 so that, the light guiding plate 200, the optical element 300 and the display panel 400 may be fixed in the receiving container. Thus, the first to fourth protrusions 220 to 250 of the light guiding plate 200, the first to fourth protrusions 320 to 350 of the optical element 300, the first to fourth elastic elements 620 to 650 and the display panel 400 are disposed contacting with each other in order between the bezel portion 510 of the top chassis 500 and the bottom portion 110 of the bottom chassis 100, so that the light guiding plate 200, the optical element 300 and the display panel 400 may be fixed in the receiving container.

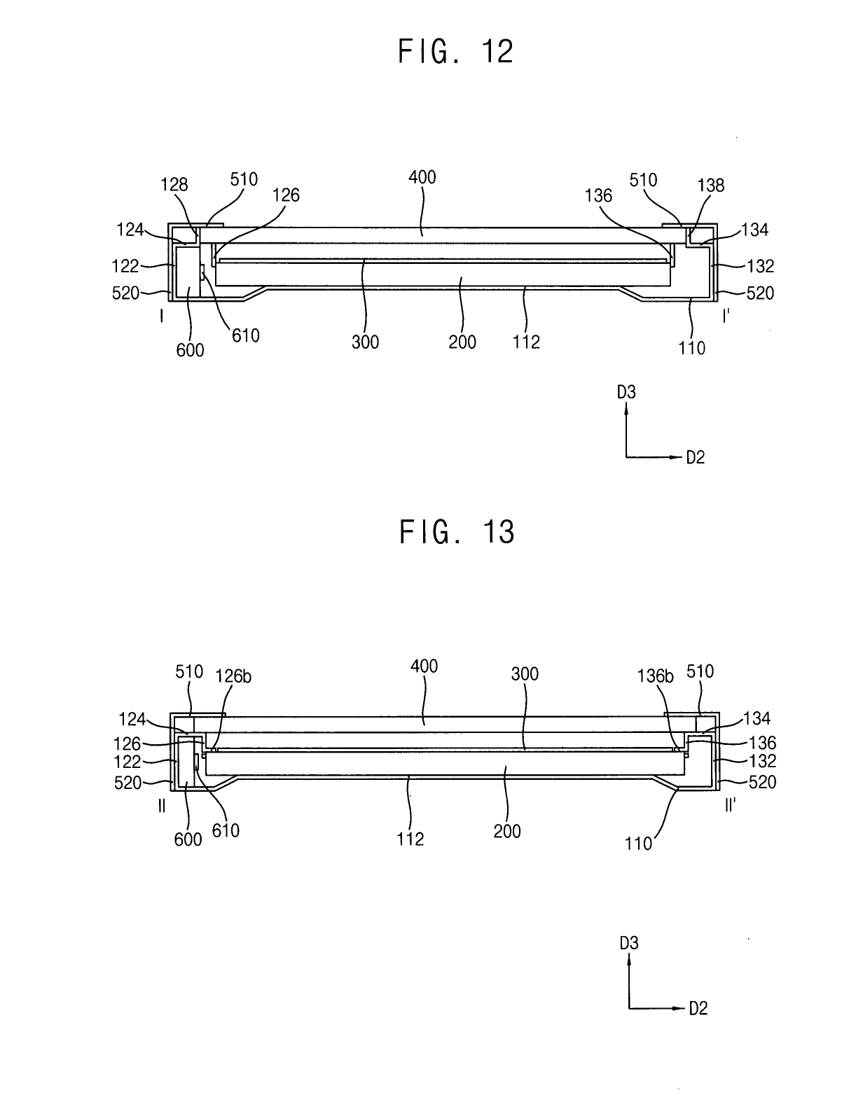

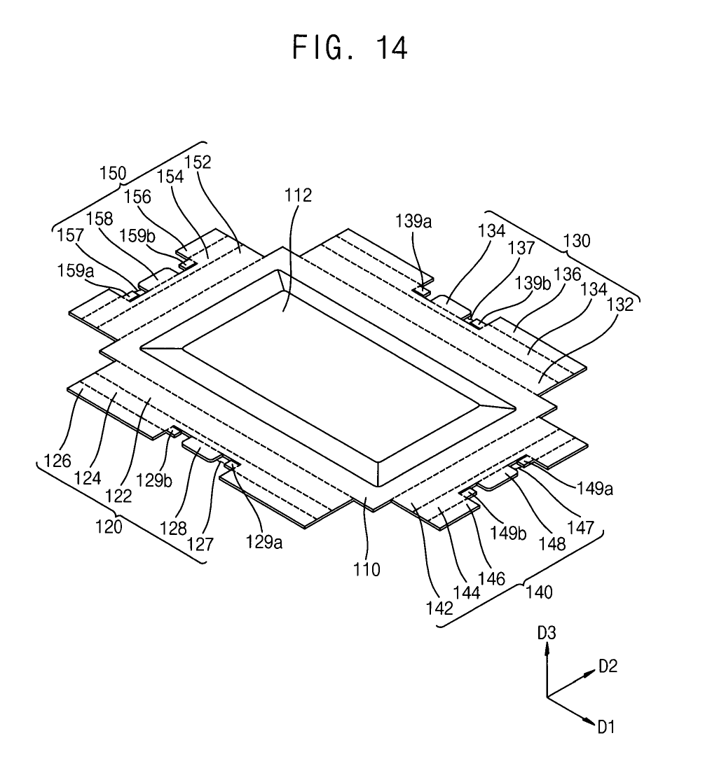

FIG. 11 is an exploded perspective view illustrating a display apparatus according an exemplary embodiment of the invention. FIG. 12 is a cross-sectional view taken along line I-I′ of FIG. 11. FIG. 13 is a cross-sectional view taken along line II-II′ of FIG. 11.

Referring to FIGS. 11 to 13, a display apparatus is substantially same as a display apparatus of FIG. 1, except for a light source part 600 and a first to fourth side portion 120 to 150. Thus, any further detailed descriptions concerning the same elements will be briefly described or be omitted.

The display apparatus includes a backlight assembly including a light guiding plate 200, an optical element 300, a display panel 400 and a receiving container. The receiving container receives a backlight assembly, an optical element 300 and the display panel 400. The receiving container includes a bottom chassis 100 and a top chassis 500. The bottom chassis 100 includes a bottom portion 110, a first side portion 120, a second side portion 130, a third side portion 140 and a fourth side portion 150.

The bottom portion 110 extends in a first direction D1 and a second direction D2 which is substantially perpendicular to the first direction D1. The bottom portion 110 may include a convex portion 112.

The first side portion 120 extends from a first side of the bottom portion 110. The first side portion 120 includes a first side wall portion 122, a first connecting portion 124 and a first light guiding plate guiding portion 126.

The first side wall portion 122 extends from the first side of the bottom portion 110 in a third direction D3 perpendicular to the first and second directions D1 and D2. The first connecting portion 124 extends from the first side wall portion 122 in parallel with the bottom portion 110. The first light guiding plate guiding portion 126 extends from the first connecting portion 124 toward the bottom portion 110.

A first display panel guiding portion 128 may be disposed on the first connecting portion 124. A portion a bottom surface of the display panel 400 makes contact with the first connecting portion 124, and the first display panel guiding portion 128 makes contact with a portion of a side surface of the display panel 400, so that the display panel 400 may be fixed in the receiving container. The first display panel guiding portion 128 may be provided by bending a portion of the first connecting portion 124.

The second side portion 130 extends from a second side of the bottom portion 110. The second side of the bottom portion 110 is opposite to the first side of the bottom portion 110 in the second direction D2. The second side portion 130 includes a second side wall portion 132, a second connecting portion 134 and a second light guiding plate guiding portion 136. The second side wall portion 132 extends from the second side of the bottom portion 110 in the third direction D3. The second connecting portion 134 extends from the second side wall portion 132 in parallel with the bottom portion 110. The second light guiding plate guiding portion 136 extends from the second connecting portion 134 toward the bottom portion 110.

The second display panel guiding portion 138 may be disposed on the second connecting portion 134. A portion a bottom surface of the display panel 400 makes contact with the second connecting portion 134, and the second display panel guiding portion 138 makes contact with a portion of a side surface of the display panel 400, so that the display panel 400 may be fixed in the receiving container. The second display panel guiding portion 138 may be provided by bending a portion of the second connecting portion 134.

The third side portion 140 extends from a third side of the bottom portion 110. The third side of the bottom portion 110 is adjacent to the first and second sides of the bottom portion 110. The third side portion 140 includes a third side wall portion 142, a third connecting portion 144 and a third light guiding plate guiding portion 146. The third side wall portion 142 extends from the third side of the bottom portion 110 in the third direction D3. The third connecting portion 144 extends from the third side wall portion 142 in parallel with the bottom portion 110. The third light guiding plate guiding portion 146 extends from the third connecting portion 144 toward the bottom portion 110.

A third display panel guiding portion 148 may be disposed on the third connecting portion 144. A portion a bottom surface of the display panel 400 makes contact with the third connecting portion 144, and the third display panel guiding portion 148 makes contact with a portion of a side surface of the display panel 400, so that the display panel 400 may be fixed in the receiving container. The third display panel guiding portion 148 may be provided by bending a portion of the third connecting portion 144.

The fourth side portion 150 extends from a fourth side of the bottom portion 110. The fourth side of the bottom portion 110 is opposite to the third side of the bottom portion 110 in the first direction D1. The fourth side portion 150 includes a fourth side wall portion 152, a fourth connecting portion 154 and a fourth light guiding plate guiding portion 156. The fourth side wall portion 152 extends from the fourth side of the bottom portion 110 in the third direction D3. The fourth connecting portion 154 extends from the fourth side wall portion 152 in parallel with the bottom portion 110. The fourth light guiding plate guiding portion 156 extends from the fourth connecting portion 154 toward the bottom portion 110.

A fourth display panel guiding portion 158 may be disposed on the fourth connecting portion 154. A portion a bottom surface of the display panel 400 makes contact with the fourth connecting portion 154, and the fourth display panel guiding portion 158 makes contact with a portion of a side surface of the display panel 400, so that the display panel 400 may be fixed in the receiving container. The fourth display panel guiding portion 158 may be provided by bending a portion of the fourth connecting portion 154.

Protruding portions 126a and 126b, 136a and 136b, 146a and 146b, and 156a and 156b may be disposed on the first light guiding plate guiding portion 126, the second light guiding plate guiding portion 136, the third light guiding plate guiding portion 146 and the fourth light guiding plate guiding portion 156, respectively. The protruding portions 126a and 126b, 136a and 136b, 146a and 146b, and 156a and 156b may be disposed on boundary portions of the light guiding plate 200 exposed by the optical element 300. Accordingly, the protruding portions 126a and 126b, 136a and 136b, 146a and 146b, and 156a and 156b may fix the light guiding plate 200 and the optical element 300.

In an exemplary embodiment, the light source part 600 may be disposed between the first connecting portion 124 and the bottom portion 110 in a cross section. In an exemplary embodiment, a light source 610 may be disposed on a surface of the light source part 600 facing a first side of the light guiding plate 200 corresponding to the first side portion 120 of the bottom chassis.

FIGS. 14 to 16 are perspective views illustrating a method of manufacturing a bottom chassis of a display apparatus of FIG. 1.

Referring to FIG. 14, a method of manufacturing a bottom chassis includes providing bottom chassis having a plate shape and including a bottom portion and first to fourth side portions.

The bottom chassis 100 includes a bottom portion 110, a first side portion 120, a second side portion 130, a third side portion 140 and a fourth side portion 150. The bottom chassis 100 may be a single, unitary, indivisible member, where portions thereof are folded such as along the dotted lines indicated in FIG. 14.

The first side portion 120 includes a first side wall portion 122, a first connecting portion 124, a first light guiding plate guiding portion 126, a first display guiding portion 128 and protrusion fixing portions 129a and 129b. In an exemplary embodiment of manufacturing the bottom chassis 100, a portion of a pre-chassis shape may be removed at the first connecting portion 124 and the first light guiding plate guiding portion 126, so that a first protrusion receiving space 127 is defined.

The second side portion 130 includes a second side wall portion 132, a second connecting portion 134, a second light guiding plate guiding portion 136, a second display guiding portion 138 and a protrusion fixing portions 139a and 139b. In an exemplary embodiment of manufacturing the bottom chassis 100, a portion of a pre-chassis shape may be removed at the second connecting portion 134 and the light guiding plate guiding portion 136, so that a second protrusion receiving space 137 is defined.

The third side portion 140 includes a third side wall portion 142, a third connecting portion 144, a third light guiding plate guiding portion 146, a third display guiding portion 148 and protrusion fixing portions 149a and 149b. In an exemplary embodiment of manufacturing the bottom chassis 100, a portion of a pre-chassis shape may be removed at the third connecting portion 144 and the third light guiding plate guiding portion 146, so that a third protrusion receiving space 147 is defined.

The fourth side portion 150 includes a fourth side wall portion 152, a fourth connecting portion 154, a fourth light guiding plate guiding portion 156, a fourth display guiding portion 158 and protrusion fixing portions 159a and 159b. In an exemplary embodiment of manufacturing the bottom chassis 100, a portion of a pre-chassis shape may be removed at the fourth connecting portion 154 and the fourth light guiding plate guiding portion 156, so that a fourth protrusion receiving space 157 is defined.

In an exemplary embodiment, the bottom chassis 100 including the first to fourth side portions 120 to 150 and the bottom portion 110 may be provided by various processes such as a press process, a cutting process, etc. In an exemplary embodiment, the bottom chassis 100 may have a plate shape, for example. In an exemplary embodiment, a convex portion 112 may be provided on the bottom portion 110 by a press process, for example.

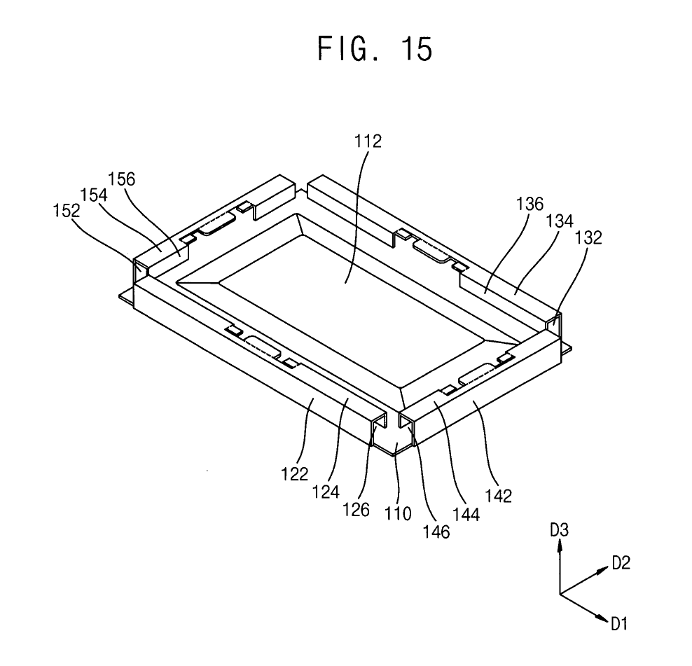

Referring to FIG. 15, the method includes a first bending step, a second pending step, and a third bending step.

In the first bending step, the first to fourth side wall portions 122, 132, 142 and 152 of the bottom chassis having a plate shape are bended in the third direction D3 which is perpendicular to the bottom portion 110.

In the second bending step, the first to fourth connecting portions 124, 134, 144 and 154 are bended in a direction which is perpendicular to the first to fourth side wall portions 122, 132, 142 and 152, respectively, and in parallel with the bottom portion 110. Accordingly, the bottom portion 110, the first to fourth side wall portions 122, 132, 142 and 152 and the first to fourth connecting portions 124, 134, 144 and 154 may provide a C-shape in a cross-sectional view, respectively.

In the third bending step, the first to fourth light guiding plate guiding portions 126, 136, 146, 156 are bended in a direction which is perpendicular to the first to fourth connecting portions 124, 134, 144 and 154, respectively, and toward the bottom portion 110.

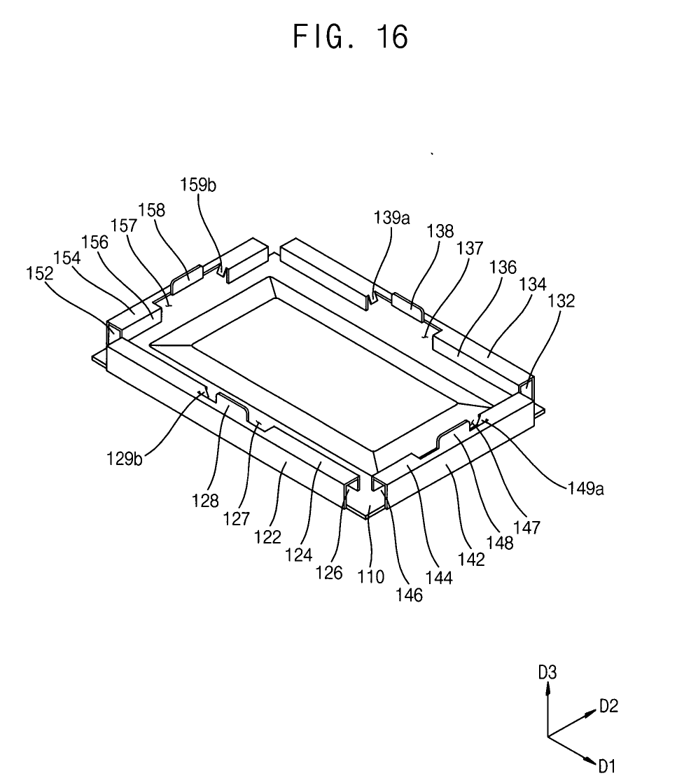

Referring to FIG. 16, the method further includes a forth bending step and a fifth bending step.

In the fourth bending step, the first to fourth display guiding portions 128, 138, 148 and 158 are bended in the third direction D3 with respect to the first to fourth connecting portions 124, 134, 144 and 154.

In the fifth bending step, each of the protrusion fixing portions 129a and 129b, 139a and 139b, 149a and 149b, and 159a and 159b is bended to be inclined from the first to fourth connecting portions 124, 134, 144 and 154, respectively, toward the bottom portion 110. Accordingly, the first to fourth protrusion receiving spaces 127, 137, 147 and 157 may be defined.

In an exemplary embodiment, the bottom chassis may be provided by various processes such as a press process, a cutting process, a bending process, etc.

According to the invention, a display apparatus includes a bottom chassis receiving a display panel, an optical element and a light guiding plate and including first to fourth side portions, so that elements in the display apparatus may be firmly fixed in the display apparatus without a mold frame. Thus, a structure of the display apparatus may be simplified.

In addition, a method of manufacturing the display apparatus includes providing the bottom chassis by a press process, a cutting process and a bending process. Thus, the method of manufacturing the display apparatus may be simplified.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A display apparatus comprising:
a display panel which displays an image;
a light guiding plate disposed under the display panel; and
a bottom chassis which receives the display panel and the light guiding plate, and comprises:
a bottom portion which is disposed in parallel with the display panel, and extends in a first direction and a second direction substantially perpendicular to the first direction;
a first side portion comprising:
a first side wall portion which extends from a first side of the bottom portion, along a third direction substantially perpendicular to the first and second directions,
a first connecting portion which extends from the first side wall portion, in parallel with the bottom portion; and
a first light guiding plate guiding portion which extends from the first connecting portion, toward the bottom portion;
a second side portion comprising:
a second side wall portion which extends from a second side of the bottom portion being opposite to the first side of the bottom portion, along the third direction,
a second connecting portion which extends from the second side wall portion, in parallel with the bottom portion; and
a second light guiding plate guiding portion which extends from the second connecting portion, toward the bottom portion;
a third side portion comprising:
a third side wall portion which extends from a third side of the bottom portion being adjacent to the first and second sides of the bottom portion, along the third direction,
a third connecting portion which extends from the third side wall portion, in parallel with the bottom portion; and
a third light guiding plate guiding portion which extends from the third connecting portion, toward the bottom portion; and
a fourth side portion comprising:
a fourth side wall portion which extends from a fourth side of the bottom portion being opposite to the third side of the bottom portion, along the third direction,
a fourth connecting portion which extends from the fourth side wall portion, in parallel with the bottom portion; and
a fourth light guiding plate guiding portion which extends from the fourth connecting portion, toward the bottom portion.

2. The display apparatus of claim 1, wherein the first light guiding plate guiding portion contacts a portion of a side surface of the light guiding plate.

3. The display apparatus of claim 1, wherein the first connecting portion contacts a portion of a bottom surface of the display panel.

4. The display apparatus of claim 3, wherein
the light guiding plate comprises a first protrusion provided on a first side surface of the light guiding plate, and
a first protrusion receiving space which receives the first protrusion of the light guide plate is defined in the first side portion of the bottom chassis.

5. The display apparatus of claim 4, wherein the first protrusion receiving space is defined by a portion of the first connecting portion and the first light guiding plate guiding portion of the first side portion.

6. The display apparatus of claim 4, wherein the first side portion further comprises a protrusion fixing portion provided at the first protrusion receiving space, and the protrusion fixing portion extends from the first side portion toward the first protrusion of the light guiding plate.

7. The display apparatus of claim 6, wherein the protrusion fixing portion is protruded from the first connecting portion of the first side portion, and the protrusion fixing portion is inclined with respect to the third direction.

8. The display apparatus of claim 6, further comprising a first elastic element which is disposed between the first protrusion and the display panel, comprises an elastic material, and contacts the display panel.

9. The display apparatus of claim 4, wherein the first side portion further comprises a first display panel guiding portion disposed on the first connecting portion and contacting a side surface of the display panel.

10. The display apparatus of claim 9, wherein the first display panel guiding portion is adjacent to the first protrusion receiving space.

11. The display apparatus of claim 4, further comprising an optical element disposed between the display panel and the light guiding plate,
wherein the optical element comprises a first protrusion protruded from a first side of the optical element, and the first protrusion of the optical element contacts the first protrusion of the light guiding plate.

12. The display apparatus of claim 4, further comprising a top chassis which is combined with the bottom chassis and comprises:
a bezel portion covering a portion of a boundary of a top surface of the display panel, and
side surfaces extending from the bezel portion.

13. The display apparatus of claim 1, wherein the first side portion further comprises a light guiding plate fixing portion protruded from the first light guiding plate guiding portion, and
the light guiding plate fixing portion contacts the light guiding plate.

14. The display apparatus of claim 13, wherein the first side portion further comprises a first display panel guiding portion disposed on the first connecting portion and contacting with a side surface of the display panel.

15. The display apparatus of claim 14, further comprising a light source which generates light and is disposed in the first side portion,
wherein the light source extends along the first side wall portion in the first direction, and is disposed between the bottom portion and the first connecting portion.

16. A display apparatus comprising:
a display panel which displays an image;
a light guiding plate disposed under the display panel; and
a bottom chassis which receives the display panel and the light guiding plate and comprises:
a bottom portion which is disposed in parallel with the display panel and extends in a first direction and a second direction substantially perpendicular to the first direction; and
a first side portion comprising:
a first side wall portion which extends from a first side of the bottom portion, along a third direction substantially perpendicular to the first and second directions,
a first connecting portion which extends from the first side wall portion, in parallel with the bottom portion; and
a first light guiding plate guiding portion which extends from the first connecting portion, toward the bottom portion,
wherein the first light guiding plate guiding portion contacts a portion of a side surface of the light guiding plate.

17. A method of manufacturing a display apparatus comprising:
providing a bottom chassis comprising: a bottom portion which extends in a first direction, and a second direction substantially perpendicular to the first direction, and first to forth side portions extending from the bottom portion;
receiving a light guiding plate into the bottom chassis by locating a first protrusion protruded from a first side surface of the light guiding plate into a first protrusion receiving space defined in the first side portion of the bottom chassis; and
locating a display panel on first to fourth connecting portions of the bottom chassis and in parallel with the bottom portion of the bottom chassis,
wherein the first side portion comprises:
a first side wall portion which extends from a first side of the bottom portion, along a third direction substantially perpendicular to the first and second directions;
the first connecting portion which extends from the first side wall portion, in parallel with the bottom portion; and
a first light guiding plate guiding portion which extends from the first connecting portion, toward the bottom portion.

18. The method of claim 17, wherein providing the bottom chassis further comprises:
providing the bottom chassis having a plate shape;
bending the first side wall portion in the third direction;
bending the first connecting portion in a direction which is substantially perpendicular to the first side wall portion and parallel to the bottom portion; and
bending the first light guiding plate guiding portion in the third direction.

19. The method of claim 18,
wherein the first side portion further comprises:
a first display panel guiding portion extending from the first connecting portion, and
a protrusion fixing portion, and
wherein providing the bottom chassis further comprises:
bending the first display panel guiding portion in the third direction; and
bending the protrusion fixing portion from the first connecting portion toward the bottom portion.

20. The method of claim 17, wherein providing the bottom chassis further comprises providing a convex portion on the bottom portion by a press process.
